(19) United States
(12) Patent Application Publication
(10) Pub. No.: US 2025/0215341 A1
(43) Pub. Date: Jul. 3, 2025

(54) METHOD OF GRILLING

(71) Applicant: Leonard Kronman, Tucson, AR (US)

(72) Inventor: Leonard Kronman, Tucson, AR (US)

(21) Appl. No.: 19/082,191

(22) Filed: Mar. 18, 2025

Related U.S. Application Data
(63) Continuation-in-part of application No. 18/803,782, filed on Aug. 14, 2024.
Application No. 18/803,782 is a continuation of application No. 17/563,935, filed on Dec. 28, 2021, now Pat. No. 12,129,443.
Application No. 17/563,935 is a division of application No. 16/399,032, filed on Apr. 30, 2019, now Pat. No. 11,208,604.

(51) Int. Cl. C10L 5/28; C10L 5/36; F23K 1/00

(52) U.S. Cl. CPC C10L 5/28; C10L 5/361; C10L 2290/02; C10L 2290/546; F23K 1/00

(57) ABSTRACT

A method of grilling on a grill includes installing a fuel support for supporting solid fuel inside the grill, wherein the fuel support comprises a substantially flat, embossed, non-expanded formed metal screen. The grill is of a type intended for cooking or grilling food solely by combusting ignitable gas. A food-supporting grill-grate is placed over the support for solid fuel and solid fuel added onto the fuel support underlying the food-supporting grill grate. The solid fuel is ignited to generate heat from combustion of the solid fuel. Food is placed on the food-supporting grill grate; cooked using the heat from the combustion of the solid fuel.

### CROSS-REFERENCE TO RELATED APPLICATIONS

This Application is a continuation-in-part of U.S. patent application Ser. No. 18/803,782, filed Aug. 13, 2024 and entitled “Method of Grilling,” which is a continuation of and claims priority to U.S. Patent 12,129,443, granted Oct. 29, 2024, entitled “Method, Fuel, and Apparatus for Grilling with Chipped Charcoal,” which is a divisional of U.S. Pat. No. 11,208,604, granted Dec. 28, 2021 and entitled “Chipped Charcoal Fuel and Method of Production Thereof,” the disclosures of which are incorporated herein by reference in their entirety.

### BACKGROUND

Grilling enthusiasts have long considered solid wood charcoal as an ideal fuel for optimum flavor, moisture retention, and texture when grilling meats and vegetables. Unlike natural gas or propane, which generates a lot of moisture as a result of the combustion thereof, solid wood charcoal generates a very hot, dry heat that is ideal for searing meat and vegetables and consequent moisture retention while cooking. Charcoal briquettes, which are often made by compressing coal dust, sawdust, charcoal dust with binding agents, are preferred by many for generating a steady heat over a long period of time, but can impart unpleasant chemical flavors and odors to food. Solid natural wood charcoal, though, generates higher heat than briquettes, for searing and faster cooking, and imparts neutral or wood smoke flavor to foods that many people prefer.

Solid wood charcoal is created by a process known as pyrolysis: the heating wood pieces to a high temperature in a low oxygen environment. This ancient process removes water and many volatile compounds and changes the chemical structure of the wood. Natural wood charcoal can be one-fourth the weight of the wood it is made from, and is naturally very brittle. Because it is so brittle, when natural wood charcoal is handled when removing from the kiln, and during processing or packaging, small pieces of wood charcoal chip away from exterior surfaces of the larger pieces. Because the outer-most portions near the surface of the wood charcoal are more directly exposed to the minimal flow of air through the kiln, they provide easier egress for volatiles from the wood than interior portions. These outer-most portions are therefore higher in concentration in fixed-carbon as a percentage of mass than the wood charcoal pieces as a whole, and are consequently also more fragile and more likely to chip away from the solid charcoal lumps. Because these small pieces would fall through traditional charcoal support structures in the grilling apparatus, they are generally considered by those in the field to be unusable in this form as a grilling fuel source. Because it is considered to be unusable, this “solid fuel” is regarded by companies involved in producing natural wood charcoal as an undesirable byproduct of production and is therefore sold, along with smaller particles and dust, at very low cost to manufacturers of charcoal briquettes or activated carbon filters.

### SUMMARY

A method of grilling on a grill includes installing a fuel support for supporting solid fuel inside the grill, wherein the fuel support comprises a substantially flat, embossed, non-expanded formed metal screen. The grill is of a type intended for cooking or grilling food solely by combusting ignitable gas. A food-supporting grill-grate is placed over the support for solid fuel and solid fuel added onto the fuel support underlying the food-supporting grill grate. The solid fuel is ignited to generate heat from combustion of the solid fuel. Food is placed on the food-supporting grill grate; cooked using the heat from the combustion of the solid fuel. In addition, other techniques and improvements to grilling are described.

### BRIEF DESCRIPTION OF THE DRAWINGS

FIG. 1A illustrates a cross-section of segment of a food grilling apparatus including a solid fuel support.

FIG. 1B shows an alternate solid fuel support structure.

FIG. 2 shows a flow chart diagram of an exemplary method for isolating high-carbon solid fuel.

FIG. 3 shows a flow chart diagram of an exemplary method for grilling food.

### DETAILED DESCRIPTION

Modern chefs and home cooks often prefer to grill meat and vegetables over natural solid wood charcoal. The inventor of the apparatus and techniques described herein successfully developed and commercialized an apparatus, previously disclosed in U.S. Pat. No. 6,161,534, which is fully incorporated herein by reference, designed for converting a natural gas or propane grill to cook with natural solid wood charcoal. The inventor, who has also successfully developed multiple brands of natural solid wood charcoal for grilling, recognized that solid fuel, previously understood to be an “unusable” byproduct of wood charcoal production, is not only usable, but is in many ways a superior fuel source for food grilling. These superior properties include, among other things, faster lighting, hotter burning, and, due to an extremely high concentration of fixed carbon, more pure combustion. However, several problems existed that heretofore had not been recognized or addressed. First, pieces of wood charcoal of appropriate size must be determined and isolated such that fuel may be added through a food grate, while still being supportable below the food grate. Second, a grid must be designed for supporting the small pieces of solid fuel while enabling sufficient airflow for optimum combustion. Finally, a method for cooking over solid fuel, uniquely enabling prolonged cooking by refueling without lifting the food grill grate or interrupting the cooking process, by passing the fuel directly through ordinary, traditional, food supporting grill grates.

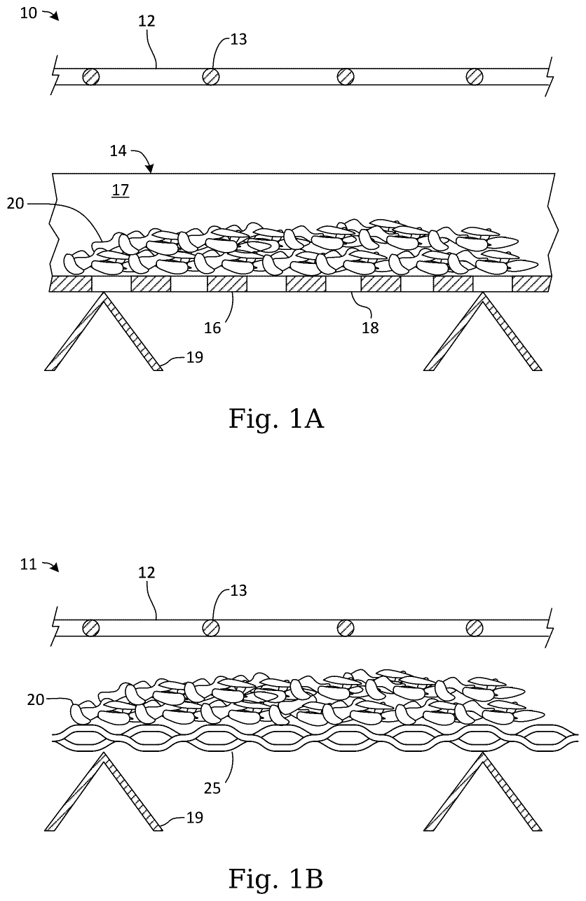

FIG. 1A shows a segment of food grilling apparatus 10 in cross-section. It should be noted that this diagram is not to scale. Apparatus 10 includes an ordinary food support grill grate 12 having consistently spaced bars for supporting food such as meats and/or vegetables. A grid 14 includes bottom perforated portion 16 with perforations 18 and an upstanding side edge 17. Solid fuel 20 is shown supported by bottom perforated portion 16. Supports 19, which may be an existing briquette support grate or heat spreaders of a gas grill, support grid 14. As described, therefore, grid 14 may be added to any traditional standard solid fuel or gas burning grilling apparatus, for supporting solid fuel as an alternative fuel source.

Grid 14, as viewed from above, may be square, rectangular, or other shape, formed from perforated metal. In one embodiment, grid 14 is formed from 14 to 20-gauge steel or aluminum with thee-eights inch round or five-sixteenths inch square perforations that make up 39% to 44% of the surface area of the perforated portions of the sheet. It has been discovered by the present inventor that these characteristics allow a balance of airflow for maximum heat generation with minimal fall-through of the solid fuel, while also maintaining structural integrity of grid 14 under the very high temperature extremes generated while grilling. Edges 17 may rise from all sides of grid 14 a distance of one-half inch. Edges 17 may vary in construction. In exemplary embodiments, edges 17 may be formed from the same sheet of metal as bottom perforated portion 16, and simply bent up and welded at the corners. In this case, edges 17 may be perforated or not perforated. In other embodiments, edges 17 may be a spot-welded half-inch metal round or square bar, or bent-metal sheet, which may vary with consumer verses commercial chef requirements. Edges 17 provide structural integrity to grid 14 as it experiences extreme heat changes and gradients. Although shown extending up from bottom perforated portion 16, grid 14 may be oriented extending down if it is desired to lift fuel supporting bottom perforated portion up from supports 19.

FIG. 1B shows an alternate grilling apparatus 11 having an alternate support structure. Screen 25 is formed of louvered perforated metal, also referred to as a non-expanded formed metal screen. It is formed by stamping to create raised and recessed sections without lateral expansion, where the alternating raised sections resemble louvered sheet metal. The metal is not laterally expanded but is mechanically deformed to create an open structure. For example, a manufacturing process includes feeding ductile sheet metal into a punch press to form parallel slits of uniform length without removing material. Then a secondary stamping operation is performed forcing alternating strips of metal between the slits upward and downward. For example, a matched die press that selectively bends the metal strips without stretching them laterally is used. The inventor discovered that this structure provides superior air flow while avoiding the torquing problems of the flat perforated metal described above with reference to FIG. 1A, which requires raised edges to ensure structural integrity in the presence of the high heat generated by solid fuel combustion. An advantage of this is that, even in some home grills with very low profiles, there will be sufficient clearance for this screen and the supported solid fuel, between the burners and the food-supporting grate. In an example implementation, support 25 is formed from 24-gauge SAE 304 stainless steel sheet metal as specified by the Society of Automotive Engineers (SAE) International. In addition, individual screens, in one example embodiment, measure about 12 inches by 14 inches, which fit inside virtually any home or professional gas grill.

Solid fuel 20, in various embodiments, is created from 100% natural virgin hardwoods which have been aged for 12-18 months prior to pyrolysis processing in kilns. Because kiln firing techniques and because only hardwoods are used, the solid fuel has a higher (ultra) fixed carbon component and fewer volatiles than typical wood charcoal found in stores and restaurant supply houses. Substantially all, but at least a majority of the pieces of solid fuel 20 is sized between one quarter to three-eighths of an inch. This enables it to easily drop through grill grate 12 and onto the grid 14, eliminating any need to stop and lift grill grate 12 to refuel.

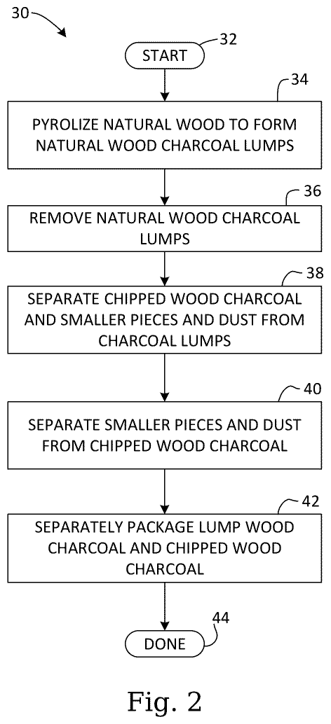

FIG. 2 shows a flowchart 30 illustrating by way of example a method for producing the novel solid fuel envisioned. The method starts at start block 32 and flows to operation 34 wherein natural wood is pyrolyzed in kilns to form natural wood charcoal lumps. These lumps are brittle and light-weight with outer-most portions being very brittle and very high in fixed carbon. As a result while removing wood charcoal lumps from the kiln in operation 36, smaller pieces, referred herein as “solid fuel,” of these outer most portions of the charcoal lumps fall away. In operation 38, the solid fuel and smaller pieces and dust are separated from lump wood charcoal. In one embodiment, to separate the chips from lumps, the lumps and chips are passed over a first screen or sieve to selectively allow solid fuel, smaller pieces, and dust to fall through the sieve while retaining the larger charcoal lumps. In one embodiment, the first sieve is configured to remove pieces that are about three-eighths of an inch in their longest dimension or smaller. The larger lumps may then be packaged as standard solid lump wood charcoal as shown in operation 42.

In operation 40, the combined solid fuel and smaller pieces and dust are passed over a second screen or sieve. In one embodiment, the second sieve is configured to remove pieces smaller than about one quarter inch, as well as any charcoal dust. In this way, solid fuel sized from between about one-quarter inch to about three-eighths of an inch are isolated. This fuel is very high in fixed carbon as compared to standard lump wood charcoal and as a result as unique and superior cooking properties. The isolated solid fuel is then packaged separately from the lump wood charcoal as shown in operation 42, and may therefore be sold as a distinct product. Method 30 then ends as indicated by “done” block 44.

It should be understood that additional screening operations may be implemented to further size out different sized lumps of charcoal, or for other purposes. However, the method described herein requires at least a first sieve to isolate chipped charcoal pieces smaller than a first size, and a second sieve to isolate those pieces from dust and other pieces smaller than a second size, which is smaller than the first size. In this way pieces of relatively consistent desirable size may be obtained. While solid fuel pieces from between one-quarter and three-eighths inch is provided as an exemplary size, other sizes may be generated using differently-configured sieves in other embodiments. However, the size from one-quarter to three-eighths inch has been determined optimal for passing through typical food supporting grill grates while still being supportable by a grid 14, when appropriately sized and configured.

Referring back to FIGS. 1A, 2B, grid 14 or screen 25 may be simply “dropped” into existing, ordinary, grilling devices, without modification thereof, directly onto a briquette support grate, or radiant bars, heat spreaders, lava rocks, etc., of consumer or commercial natural gas or propane grills. Use of gas grills has the advantage that solid fuel 20 may be ignited simply by running the gas burners a short time, until ignited, or left on, if desired, for example, to provide extra heat and to maintain even combustion of the solid fuel. In a charcoal grill, such as a Weber® kettle-style charcoal grill, the chipped charcoal may be ignited in various ways, from the use of existing electric ignition devices, to using a butane torch, or even lighter fluid or lighter blocks used for starting wood fires. Solid fuel will ignite easily and burn hotter, and leave very little ash in comparison to standard briquettes and other wood fuels. Once fully ignited, cooking may begin immediately, since solid fuel has very few volatiles (unlike briquettes) and will only enhance the flavor of grilled meats and vegetables.

While chipped charcoal has the advantage of being pyrolyzed, thereby creating a high-carbon natural solid fuel that generates very hot and very dry heat, other types of solid fuels are compatible with grid 14 and screen 25. For example, natural wood pellets are commercially available and formed, from finely-ground saw dust, into pellets by applying extreme pressure. Natural wood pellets produce fragrant smoke that many people appreciate. Other forms of solid fuel, such as solid charcoal pellets, that can pass through the food grate can be similarly used.

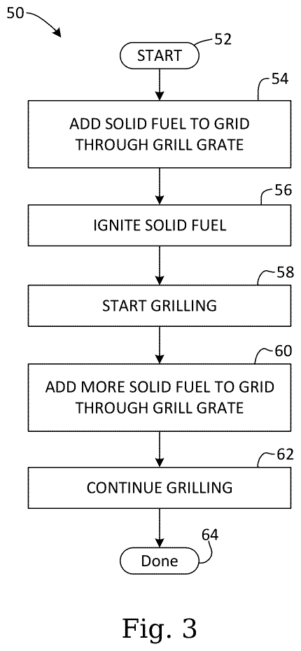

FIG. 3 shows flowchart 50 illustrating by way of example a method of grilling food with grid 14 shown in FIG. 1A or support structure 25 shown in FIG. 1B. This method will be described below with reference to FIGS. 1A and 1B. An initial step, not shown, may include adding grid 14 or screen 25 to an existing consumer or commercial grilling apparatus, such as a typical solid fuel or gas or propane grill. The grid or screen may be added simply by lifting food supporting grill grate 12 and dropping grid 14 directly onto solid fuel support, or in a gas or propane grill, heat spreaders, bars, lava rocks, etc., as previously described, and then replacing food supporting grill grate 12. Once the grilling apparatus is so configured, method 50 begins as indicated by start block 52 which flows to operation 54, wherein solid fuel is added to grid 14 through food supporting grill grate 12. As previously described, the solid fuel is sized to easily fall through food supporting grill grate while grid 14 and screen 25 are configured for supporting solid fuel, allowing only minimal fall-through thereof, and providing sufficient airflow to maintain optimum burning and consequential heat generation. Since the fuel is a natural wood product, any dust or small pieces adhering to the food supporting grill grate pose no or minimal health risk, and at any rate is likely to burn away during the cooking process.

After the fuel is added to grid 14, it may be ignited by the grilling apparatus's existing gas or propane burners. The gas or propane is used to ignite the solid fuel, and then optionally turned off during cooking. Alternatively, a butane torch or electric ignition device may be used to ignite the solid fuel. Once ignited, method 50 flows to operation 58 where food may immediately be added to the food supporting grill grate 12 for commencement of grilling. If grilling requires continuous heat over a long period of time such that additional fuel is required to be added to grid 14, additional fuel may be added as shown by operation 60, without lifting the food supporting grill grate 12 and therefore without interrupting the grilling of food. Then, in operation 62, the food continues to be grilled after the fuel is added. The method then ends as indicated by “done” block 64.

As explained above, the present invention has significant advantages when grilling with a gas grill over prior food grilling systems. For example, due to high heat output, it provides for decreased food grilling time. Secondly, it provides for instant, non-stop refueling. Third, the use of natural solid fuel adds natural wood grilled food flavors. Fourth, superior dry heat sears food for better internal moisture retention in any kind of meat and many vegetables. Fifth, because the solid fuel comprises smaller pieces of solid fuel than traditional fuels, it actually packs denser and therefore less is required to grill foods, and for the same weight in fuel, less storage space than traditional solid wood fuels. These and other advantages would be recognized by experts and grilling enthusiasts.

Described hereinabove are a method for isolating a unique and desirable material useful as fuel for grilling food, a grid for supporting said fuel within existing traditional solid fuel and gas or propane grilling apparatuses, and a method for using such modified grilling apparatuses for cooking food and for adding fuel thereof while cooking, in an uninterrupted way.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

What is claimed is:

1. A method for grilling food on a grill, the method comprising:
installing a fuel support for supporting solid fuel inside the grill, the grill being intended for cooking or grilling food solely by combusting ignitable gas, and placing a food-supporting grill-grate over the support for solid fuel, wherein the fuel support comprises a non-expanded formed metal screen;
without lifting any portion of the food-supporting grill grate, adding solid fuel having a size of at least one-fourth an inch in dimension through the food-supporting grill grate onto the fuel support underlying the food-supporting grill grate, wherein the food-supporting grill grate comprises spaced bars for supporting food and providing a cooking area and the solid fuel can be added to the fuel support directly beneath any portion of the cooking area by passing the solid fuel between any adjacent ones of the spaced bars;
igniting the solid fuel to generate heat from combustion of the solid fuel;
placing the food on the food-supporting grill grate over the solid fuel; and
cooking the food on the food-supporting grill grate using the heat from the combustion of the solid fuel.

2. The method of claim 1, wherein the spaced bars of the food-supporting grill grate comprises consistently spaced bars.

3. The method of claim 1, wherein the installing of the fuel support comprises lifting the food-supporting grill grate and placing the fuel support on top of an existing support within the grill, wherein the existing support comprises heat spreaders of burners of a gas grill and the igniting comprises lighting the gas grill.

4. The method of claim 3, wherein the heat spreaders comprise one of radiant bars, lava rocks, or drip shields associated with a gas or propane burner.

5. The method of claim 1, wherein the solid fuel is smaller than a particular size less than three-eighths inches in their longest dimension.

6. The method of claim 1, wherein the solid fuel is high carbon natural wood charcoal and is sized by separating other pieces of wood charcoal and wood charcoal dust from the solid fuel by passing the solid fuel, the other pieces of wood charcoal and the wood charcoal dust over a screen allowing the other wood charcoal and the wood charcoal dust to be removed and keeping the solid fuel that is sized between one quarter to three-eighths of an inch.

7. The method of claim 1, wherein the grill includes a gas burner disposed beneath the fuel support, the gas burner being configured to combust natural gas propane gas.

8. The method of claim 1, wherein the igniting of the solid fuel comprises lighting a gas burner of the grill.

9. The method of claim 8, wherein the cooking of the food comprises applying heat to the food, the heat being generated from combustion of the solid fuel and from the gas burner.

10. The method of claim 8, further comprising shutting off the gas burner upon igniting the solid fuel.

11. The method of claim 1, wherein adding the solid fuel through the food-supporting grill grate onto the fuel support comprises adding solid fuel through the food-supporting grill grate directly onto the fuel support.

12. A method for adding solid fuel to a grill, the method comprising:
adding the solid fuel having a size of at least one-fourth an inch in dimension through a food-supporting grill grate onto a fuel support underlying the food-supporting grill grate, wherein:
the food-supporting grill grate comprises spaced bars for supporting food and providing a cooking area;
the fuel support comprises a non-expanded formed metal screen;
the solid fuel can be added to the fuel support directly beneath any portion of the cooking area by passing the solid fuel between any adjacent ones of the spaced bars; and
the adding is performed without lifting or moving any portion of the food-supporting grill grate; and
igniting the solid fuel to initiate combustion of the solid fuel to generate heat, wherein, during the combustion of the solid fuel, additional solid fuel can be added to the fuel support directly beneath any portion of the cooking area by passing the solid fuel between the adjacent ones of the spaced bars of the food-supporting grill grate without lifting or moving any portion of the food-supporting grill grate to provide continuous heat from the combustion of the solid fuel and the additional solid fuel.

13. The method of claim 12, further comprising using the heat generated from the combustion of the solid fuel to cook food by adding food to the cooking area directly over the solid fuel added to the fuel support.

14. The method of claim 12, wherein the spaced bars of the food-supporting grill grate comprises consistently spaced bars.

15. The method of claim 12, wherein the fuel support is on top of an existing support within the grill.

16. The method of claim 15, wherein the grill is a gas grill, and wherein the existing support comprises heat spreaders of the gas grill and the igniting comprises lighting the gas grill.

17. The method of claim 16, wherein the heat spreaders are one of radiant bars, lava rocks, or drip shields associated with a gas or propane burner.

18. The method of claim 12, wherein the solid fuel is smaller than a particular size less than three-eighths inches in their longest dimension.

19. The method of claim 12, wherein the adding of the solid fuel through the food-supporting grill grate onto the fuel support comprises adding the solid fuel through the food-supporting grill grate directly onto the fuel support.

20. A method of grilling on a grill, the method comprising:
installing a fuel support for supporting solid fuel inside the grill, the grill being intended for cooking or grilling food solely by combusting ignitable gas, and placing a food-supporting grill-grate over the support for solid fuel, the fuel support comprising a substantially flat, embossed, non-expanded, formed metal screen;
adding solid fuel onto the fuel support underlying the food-supporting grill grate;
igniting the solid fuel to generate heat from combustion of the solid fuel;
placing the food on the food-supporting grill grate; and
cooking the food on the food-supporting grill grate using the heat from the combustion of the solid fuel.
